(19) United States
(12) Patent Application Publication
(10) Pub. No.: US 2016/0252160 A1
(43) Pub. Date: Sep. 1, 2016

(54) ANGULAR SPEED REDUCTION DEVICE

(71) Applicant: MOTEURS ALEXANDRE, Saint-Georges-sur-Eure (FR)

(72) Inventor: Tiên Phu LÊ, CHARTRES (FR)

(73) Assignee: Moteurs Alexandre, Saint-Georges-sur-Eure (FR)

(21) Appl. No.: 15/024,195

(22) PCT Filed: Sep. 24, 2014
(86) PCT No.: PCT/EP2014/070368

§ 371 Date: Mar. 24, 2016

(30) Foreign Application Priority Data
Sep. 24, 2013 (FR) 1359180

(51) Int. Cl. F16H 1/46

(52) U.S. Cl. CPC F16H 1/46

(57) ABSTRACT

An angular speed reduction device, including a first circular component passing through the center of a stationary plate and turning freely relative to said plate at an angular speed W1, wherein the first component is a gearing with a second component comprising at least one planetary gear rigidly connected to the stationary plate via an end piece integral with the planetary gear and serving as an axis of rotation, each planetary gear being freely rotatable relative to the stationary plate and driven by the first component, the planetary gears in contact with the interior of a first ring gear driven by the second component at the angular speed W2. The ring gear and the first component are concentric and the first ring gear is rigidly connected to a second ring gear so that the first ring gear drives the second ring gear at the same angular speed W2.

### TECHNICAL FIELD OF THE INVENTION

The present invention relates to a mechanical device allowing the generation of a smaller output angular rotation speed than the input rotation speed. More explicitly, the invention relates to a device for reducing rotation speed.

### TECHNICAL BACKGROUND OF THE INVENTION

Rotation speed reducers are known from the prior art which modify the speed ratio between the input axis and the output axis.

There are in particular conventional speed reducers, including a pinion connected to the input axis, said pinion meshing a wheel connected to an output axis, the inside diameter of the wheel being greater than the outside diameter of the pinion. Thus, the angular velocity or angular speed of the wheel driven by the pinion is lower than the angular velocity of the pinion, that latter communicating the speed of rotation of the input axis. However, without a complex and costly assembly including a large number of axes, pinions and wheels, this type of reducer offers only a little latitude of operation, few ratios between the input angular velocity and the output angular velocity being available.

Also known from the prior art are so-called planetary speed reducers. Such a reducer comprises at least one pinion to which is communicated the input angular velocity, the pinion meshing with planet gear wheels the axes whereof are connected to a plate, the planet gears in turn meshing a ring gear. The output angular velocity, reduced by the planet gear/ring gear assembly is communicated either to the plate connecting the planet gears or to the ring gear. These planetary reducers are quieter and make it possible to obtain more ratios between the input and the output velocities than conventional reducers. On the other hand, the latter are bulky and costly to manufacture.

U.S. Pat. No. 1,604,112 discloses a particular speed reducer, combining planetary reducers and other gear. This reducer comprises an axis driving, on the one hand a plurality of planet gears, which for their part mesh the internal teeth of a ring gear, and on the other hand a second gear mounted on a first intermediate axis. This second gear drives a third gear on a second intermediate axis, said second axis comprising a fourth gear meshing the external teeth of the ring gear. The second gear transmits the rotational motion without causing any reduction, so that the direction of rotation of the second intermediate axis is identical to the direction of rotation of the driving axis. However, this type of reducer is very bulky and costly, because of many parts which do not participate in the speed reduction.

Patent EP 0,936,382 discloses a speed reducing device comprising on the one hand a first element including at least one pinion and a second element including at least one ring gear, the two elements having the same fixed center and different radii, and having non-zero rotational velocities. The device comprises a third circular element including at least one planet gear, in contact with the pinion(s) and the ring gear(s), the third element having its center describe, at a determined speed, a circular trajectory the radius whereof is comprised between the radii of the two other elements. Thus, by applying the known angular velocities to any two elements of the reducer, an angular velocity of the last element is deduced, the dimensional parameters of all the elements of the device being known. However, the assembly of the axes in the different elements and the adjustment of the stability of rotation of the elements with respect to one another require time and great precision.

### GENERAL DESCRIPTION OF THE INVENTION

The present invention therefore has as its object to propose an angular velocity reduction device allow to mitigate one or more of the drawbacks of the prior art. To this end, the invention proposes a reduction device requiring few assembly steps and the rotational stability whereof of the various elements composing it is improved.

For this purpose, the invention relates to an angular velocity reducing device comprising a first circular element crossing the center of a fixed plate and turning freely with respect to said plate at an angular velocity W₁, characterized in that this first element is meshing with a second element including at least one planet gear integral with the fixed plate through an end piece as a single piece with said planet gear and serving as an axis of rotation, each planet gear being freely rotating with respect to the fixed plate and driven by the first element, the planet gears being in contact with the interior of a first ring gear driven by the second element at the angular velocity W₂, said ring gear and the first element being concentric, the first ring gear being integral with a second ring gear so that the first ring gear drives said second ring gear at the same angular velocity W₂, a third element being meshing with the first element and the internal portion of the second ring gear, the center of the third element being driven by the first element and the second ring gear at the angular velocity W_{O3} along a circular trajectory with a predetermined radius intermediate between the radius of the first element and the internal radius of the second ring gear, the third element comprising at least one planet gear mounted freely rotating in an output plate by an end piece as a single piece with the planet gear and serving as a rotation axis, each planet gear being freely rotating about its axis, the third element driving the output plate at the angular velocity W₃, the output plate further including at least one end piece serving as an output axis, this axis and the first element being concentric, the parts of the device being inserted into a guide tube positioned in the flange or the frame of a motor, the outside diameter of the second ring gear and the diameter of the output plate of the device being equal and adapted to the diameter of the bore of the guide tube, so that there is no mechanical clearance between,on the one hand the internal wall of the guide tube, and on the other hand the output plate, the third element and the second ring gear, the guide tube further comprising at its other end an annular rim designed to accommodate an attachment plate positioned facing the output plate and fixed to the guide tube via at least one screw or one pin, the attachment plate comprising an opening through which protrudes the end piece of the output plate serving as an output axis, said end piece being freely rotating with respect to the attachment plate.

According to another feature, the angular velocity reduction device is characterized in that each end piece of the planet gears of the second and third elements comprises at its end a blocking system preventing the planet gear from disengaging from the corresponding plate wherein said planet gear is rotatably mounted.

According to another feature, the angular velocity reduction device is characterized in that the parts of said device are made of metal that is sintered or cut from a solid.

According to another feature, the angular velocity reduction device is characterized in that on the one hand the first element consists of the axis of the motor in which two pinions are formed, the first pinion driving the second element and the second pinion driving the third element, and on the other hand the fixed plate is integral with the frame of the motor.

According to another feature, the angular velocity reduction device is characterized in that on the one hand the first element comprises an axis driven by the motor, said axis including a first pinion rigidly mounted on the axis and driving the second element, the axis further including a second pinion rigidly mounted on the axis and driving the third element, the inside diameter of the first pinion being greater than the outside diameter of the second pinion, and on the other hand the fixed plate is integral with the frame of the motor.

According to another feature, the angular velocity reduction device is characterized in that on the one hand the first element comprises an axis driven by the motor, said axis including a first pinion rigidly mounted on the axis and driving the second element, a second pinion driving the third element being directly formed in the axis, and on the other hand the fixed plate is integral with the frame of the motor.

According to another feature, the angular velocity reduction device is characterized in that the teeth of the pinions of the first element are different.

According to another feature, the angular velocity reduction device is characterized in that the first element consists of the axis of the motor in which is formed a single pinion driving both the second element and the third element.

According to another feature, the angular velocity reduction device is characterized in that the pinions, planet gears and ring gears have the same module.

According to another feature, the angular velocity reduction device is characterized in that the axis of the first element is a motor axis to which is applied a source angular velocity W₁ intended to be reduced.

According to another feature, the angular velocity reduction device is characterized in that one of the two ring gears comprises a skirt without teeth wherein the other ring gear is fitted.

According to another feature, the angular velocity reduction device is characterized in that one of the two ring gears is fixed to the interior of the ring gear having a skirt, by means of at least one pin or at least one screw inserted parallel or perpendicular to the axis of the first element.

According to another feature, the angular velocity reduction device is characterized in that the end pieces serving as the axis of the planet gears of the second and third elements comprise a groove in a plane perpendicular to the axis of symmetry of the planet gear, an O-ring being designed to be inserted into this groove so that the connection between the axis of each planet gear and the corresponding plate is sealed while still ensuring free rotation in the plate of the planet gear about its axis.

According to another feature, the angular velocity reduction device is characterized in that the guide tube comprises at least one shoulder, for holding the fixed plate and allowing the attachment of the guide tube onto the flange or the frame of the motor using at least one screw or one pin.

According to another feature, the angular velocity reduction device is characterized in that the parts of the devices as well as the frame of the motor are inserted into the guide tube.

According to another feature, the angular velocity reduction device is characterized in that output plate comprises, at its other end, a second end piece serving as an output axis, the first and second end pieces being aligned and positioned on either side of output plate, the second end piece being designed to be inserted into the axis of the first element, said axis being hollow and with an inside diameter greater than the diameter of the second end piece so that the latter is freely rotating at the angular velocity W_{O3}.

The invention, with its characteristics and advantages, will be revealed more clearly upon reading the description made with reference to the appended drawings wherein:

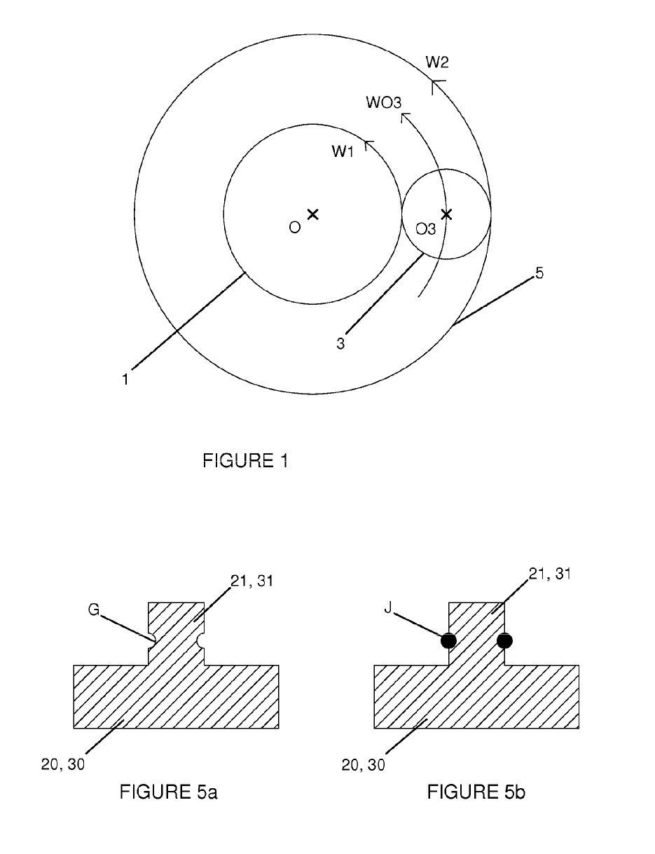

FIG. 1 illustrates a schematic layout of the angular velocity reduction device according to the invention;

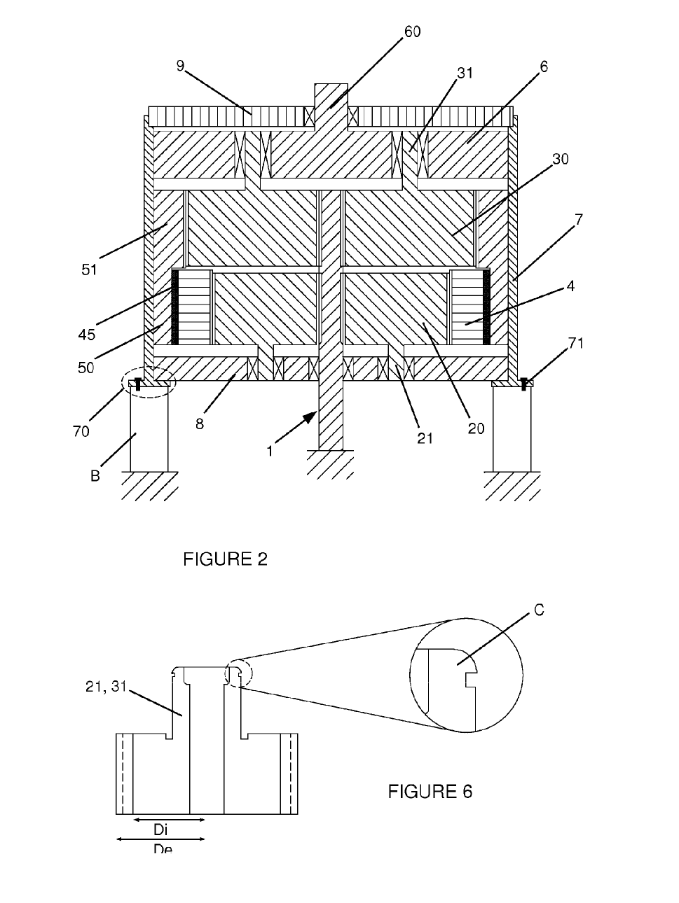

FIG. 2 illustrates a sectional view of the angular velocity reduction device and of the flange of the motor;

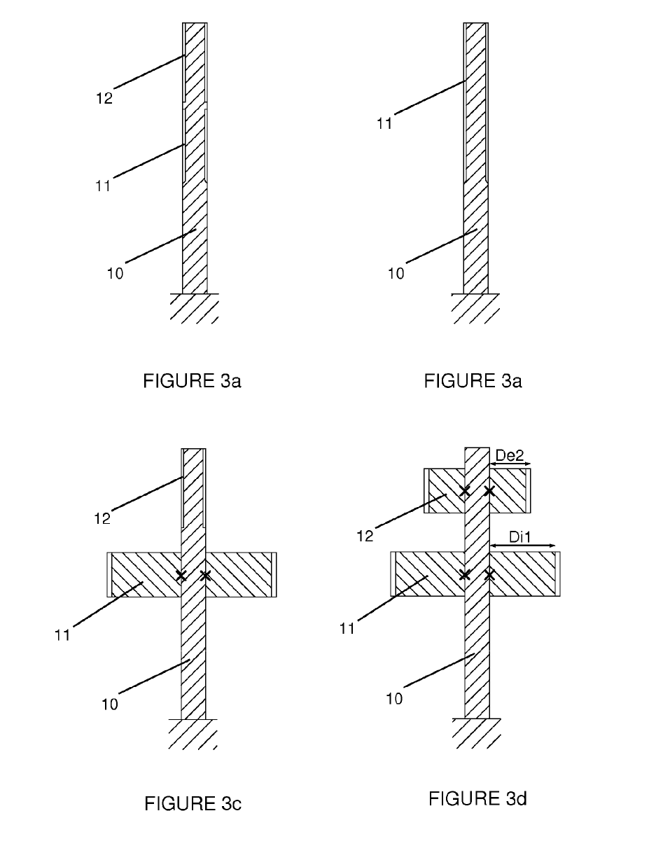

FIG. 3a illustrates a sectional view of the first element in one embodiment;

FIG. 3b illustrates a sectional view of the first element in another embodiment;

FIG. 3c illustrates a sectional view of the first element in another embodiment;

FIG. 3d illustrates a sectional view of the first element in another embodiment;

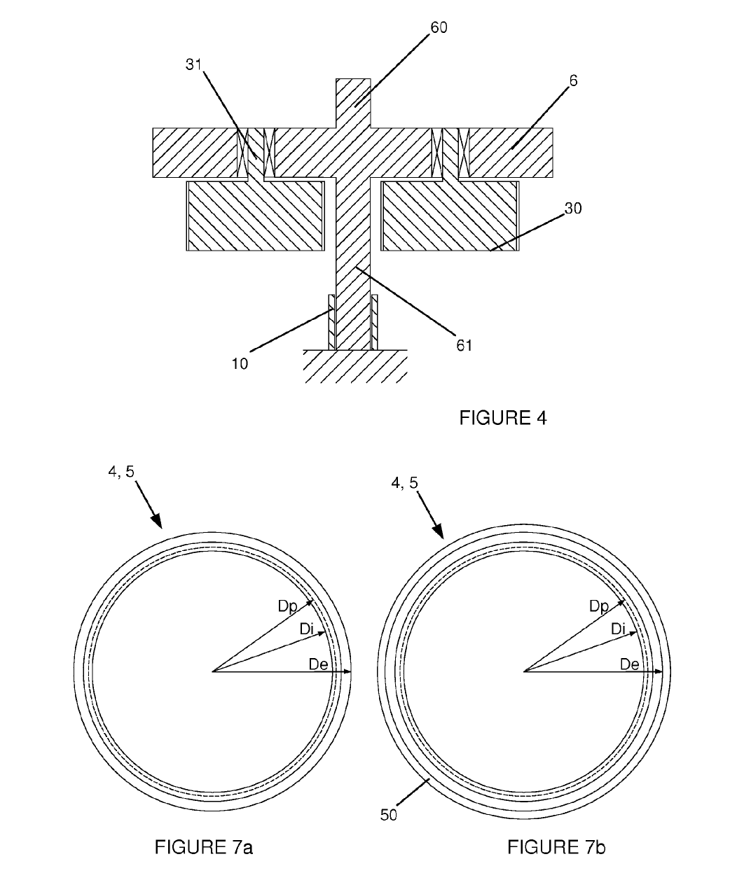

FIG. 4 illustrates a sectional view of the output plate in an alternative embodiment;

FIG. 5a illustrates a sectional view of a planet gear of the first or of the third element, the planet gear comprising a groove;

FIG. 5b illustrates a sectional view of a planet gear of the first or of the third element, the planet gear comprising an O-ring inserted into the groove;

FIG. 6 illustrates a sectional view of a planet gear of the first or of the third element, the planet gear comprising a blocking system at the end of its end piece;

FIG. 7a illustrates a top view of a ring gear;

FIG. 7b illustrates a top view of a ring gear comprising a skirt.

### DESCRIPTION OF THE PREFERRED EMBODIMENTS OF THE INVENTION

The invention will now be described by reference to FIGS. 1 to 7.

In one embodiment, the angular velocity reduction device according to the invention comprises a first circular element (1) passing through a fixed plate (8) for example with respect to the frame (B) or the flange of a motor comprising the speed reduction device. This first element (1) freely rotates with respect to the fixed plate (8) at an angular velocity W₁. This first element is meshing with a second element (2) including at least one planet gear (20), each planet gear of the second element being freely rotating about its axis. In one embodiment, each planet gear comprises an end piece (21) as a single piece with the planet gear, made of sintered metal or cut from a solid of the planet gear, the end piece serving as an axis of rotation of the planet gear. These planet gears (20) are integral with the fixed plate (8) through the end piece (21) of each planet gear, the planet gears (20) of the second element being freely rotating about their respective axis. In one embodiment, each end piece (21) comprises a blocking system (C) preventing the planet gear (20) from disengaging from the fixed plate (8) wherein said planet gear is rotatably mounted. Each planet gear of the second element is driven without slipping by the first element (1) and turns at an angular velocity different from the angular velocity of the first circular element. In one embodiment, the first element comprises an axis (10) including at least one pinion (11) the teeth whereof mesh the teeth of the planet gears (20) of the second element. For example and without limitation, the first element (1) consists of the axis of a motor. The source angular velocity W₁ is applied to the first element (1), said speed being intended to be reduced by the device according to the invention.

In one embodiment, the planet gears (20) of the second element are in contact with the interior of a first ring gear (4), said ring gear (4) and the first element (1) being concentric. The planet gears (20) of the second element drive the first ring gear (4) without slipping, which acquires a rotation speed W₂. In one embodiment, the teeth of the planet gears (20) of the second element mesh the teeth present inside the first ring gear (4).

In one embodiment, the first ring gear (4) is made integral with a second ring gear (5) so that the first ring gear (4) is fixed with respect to the second ring gear (5), the first ring gear (4) thus driving the second ring gear (5) in rotation at the same angular velocity W₂. In one embodiment, one of the two ring gears (4, 5) comprises a skirt (50) without teeth wherein the other ring gear (4, 5) is fitted. In one embodiment, one of the two ring gears is attached to the inside of the ring gear having a skirt (50), for example and without limitation using at least one pin (45) or at least one screw, inserted parallel or perpendicular to the rotation axis (10) of the first element (1). Preferably, one of the two ring gears is attached to the inside of the ring gear having a skirt (50), for example and without limitation using two pins (45) or two screws, inserted parallel or perpendicular to the rotation axis (10) of the first element (1). Thus, the mode of attachment of one ring gear with respect to the other through the skirt (50) makes it possible to reduce the bulk of the device according to the invention. In a preferred embodiment, the teeth of the two ring gears (4, 5) are different. On the other hand, the ring gears being different, is possible to position the ring gears (4, 5) in any way with respect to one another. In other words, when viewing the two ring gears concentric by their axis of rotation (O), it is possible to position the teeth of the first ring gear with respect to the second in any manner, for example and without limitation so that the teeth are aligned or not, or for example so that each point of the teeth of the first ring gear coincides with each hollow of the teeth of the second ring gear. Thus, the use of the two different concentric ring gears makes it possible to obtain, with only two stages of reduction, that is the two concentric rings (4, 5), a very great variety of reduction ratios, from the weakest to the highest, for example and without limitation well above 10,000, even 100,000, while still having a very small bulk of the reduction device. On the other hand, the fact of using only two reduction stages reduces considerably the losses relating to friction in the teeth of the gears, which are, in the conditions of the invention, only on the order 4 to 5% losses.

In one embodiment, the angular velocity reduction device comprises a third element (3) meshing with the first element (1) and the internal portion (51) of the second ring gear (5), for example, which is not in contact with the first ring gear (4). The center (O3) of this third element, which is not concentric with the ring gears and the first element, is driven by the first element (1) and by the teeth of the second ring gear (5) at a speed W_{O3} along a circular trajectory of predetermined radius (R3) intermediate between the radius (R1) of the first element and the radius (R2) of the second ring gear (5). The mathematical relations connecting on the one hand the radii and on the other hand the rotational velocities of the different elements are described in the European patent having EP 0,936,382 as its publication number.

In one embodiment, the third element comprises at least one planet gear (30), said planet gear comprising an end piece (31) as a single piece with the planet gear (30) and serving as an axis of rotation of said planet gear. As for the planet gears (20) of the second element, the axis of a planet gear (30) of the third element is therefore fixed with respect to the planet gear itself. Each planet gear of the third element is mounted freely rotating, via its end piece (31) in an output plate (6) so that the planet gears of the third element drive the output plate in rotation at the angular velocity W_{O3}. In one embodiment, each end piece (31) comprises a blocking system (C) preventing the planet gear (30) from disengaging from the output plate (6) wherein said planet gear is rotatably mounted. In one embodiment, the output plate comprises an end piece (60) serving as an output axis, this axis and the first circular element (1) being concentric.

In an alternative embodiment, the output plate (6) comprises a second end piece (61) serving as a second output axis. The two end pieces (60, 61) of the output plate (6) are concentric, preferably with the same radius, and positioned on either side of the output plate. The second end piece (61) is designed to be inserted into the axis (10) of the first element (1), said axis being hollow in this case and with an internal radius greater than the radius of the second end piece (61) serving as the second output axis, so that the second output axis is free to rotate at the angular velocity W_{O3}.

In one embodiment, the end pieces (21, 31) of the planet gears (20, 30) of the second and third elements comprise a groove (G) located in a perpendicular plane to the axis of symmetry of the planet gear, the groove (G) allowing the placement and maintenance of an O-ring (J), having elastic properties for example. The presence of such a seal on the end piece (21, 31) serving as the axis of each planet gear (20, 30) makes it possible to ensure the sealing of the connection between the end piece of each planet gear and the corresponding plate (6, 8), while still ensuring free rotation of each planet gear about its axis.

In one embodiment, the first element (1) comprises an axis including two pinions (11, 12), the first pinion (11) driving the second element and the second pinion (12) driving the third element. The pinions comprise teeth meshing the planet gears of the second and third elements of the device. In one embodiment, the two pinions have the same number of teeth. In an alternative embodiment, the two pinions have the same number of teeth and the same module. In an alternative embodiment, the teeth of the two pinions (11, 12) are different so as to attain high reduction ratios, for example and without limitation greater than 4000. It is important to note that the invention can achieve much higher reduction ratios by taking advantage on the one hand of the teeth of the pinions (11, 12), planet gears (20, 30) and ring gears (4, 5) and on the other hand of the dimensions of the parts of the device. Thus, any reduction ratio can be achieved by the invention.

In one embodiment, the teeth of the pinions (11, 12) of the first element are directly formed in the axis. For example and without limitation, the teeth of the two pinions (11, 12) are directly cut in the axis. In particular in this embodiment, the first element (1) consists of the axis of the motor. When the numbers of teeth and modules of the first and the second pinion are identical, it is then possible to create a single pinion designed to mesh both the planet gears of the second element and the planet gears of the third element. This single pinion (11) thus behaves like two pinions driving respectively the second and third elements, and having the same number of teeth and the same module.

In an alternative embodiment, the first pinion (11) of the first element (1), designed to drive the second element, is rigidly mounted on the axis (10) of the first element, while the teeth of the second pinion (12) driving the third element are directly formed in the axis of the first element (1). For example and without limitation, the teeth are directly cut into the axis.

In an alternative embodiment, the two pinions (11, 12) are rigidly mounted on the axis (10) of the first element, the inside diameter (Di₁) of the first pinion (11) driving the second element being greater than the outside diameter (De₂) of the second pinion (12) driving the third element. The inside diameter of a pinion is understood to be the diameter of the pinion without taking its teeth into account, and by the outside diameter of a pinion is meant the diameter of the pinion comprising its teeth. Note that the primitive diameter of a gear (Dp), well known to a person skilled in the art, is a virtual diameter comprised between the inside diameter (Di) and the outside diameter (De) of the gear.

In one embodiment, the planet gears (20, 30) of the second and third elements, the ring gears (4, 5) and the pinions (11, 12) of the first element have the same module.

It is important to note that the different elements and ring gears can have rotational movements in one direction or in the other. The different elements are blocked in translation with respect to one another and with respect to a fixed reference, for example the frame (B) of the motor comprising the angular velocity reduction device.

In one embodiment, the different elements and the ring gears of the angular velocity reduction device are inserted into a guide tube (7), said guide tube being itself made integral with the flange or the frame (B) of the motor. In one embodiment, the outside diameter of the ring gear comprising a skirt, for example and without limitation the second ring gear (5), and the diameter of the output plate (6) are equal, and matched with the diameter of the bore of the guide tube (7) so as to avoid any mechanical clearance between on the one hand the internal wall of the guide tube (7) and on the other hand the second ring gear (5), the third element and the output plate (6). The matching of the diameter of the parts, so as to avoid mechanical clearances between them, is perfectly known to a person skilled in the art, the diameter of the bore being greater than the outside diameter of the second ring gear and to the diameter of the plate: for example and without limitation, the diameter of the bore of the guide tube is greater by a few hundredths of millimeters, for example between 1 hundredth and 2 hundredths of millimeters, than the diameter of the output plate and the outside diameter of the second ring gear. In one embodiment, the parts (1, 2, 3, 4, 5, 6, 8, 9) of the device according to the invention as well as the frame (B) of the motor are inserted into the guide tube (7).

In one embodiment, the guide tube (7) comprises at one end a double shoulder (70) for holding the angular velocity reduction device to the flange or the frame (B) of the motor. The first shoulder is designed for holding the fixed plate (8) integral with the second element. The second shoulder is designed for attaching the guide tube (7) to the flange or frame (B) of the motor, for example and without limitation using at least one pin (71) or at least one screw. In an alternative embodiment, the guide tube is fitted by force into a groove machined in the flange or the frame of the motor.

In one embodiment, the guide tube (7) comprises, on its other end, means designed to accommodate an attachment plate (9) positioned facing the output plate (6). For example and without limitation, an annular rim machined in the end of the guide tube (7) accommodates this attachment plate (9), said plate being attached to the guide tube via for example a screw or a pin. On the other hand, the attachment plate has at its center an opening through which passes the end piece (60) of the output plate, the diameter of the opening of the attachment plate being greater than the diameter of the end piece of the output plate, so that said end piece is free to rotate with respect to the attachment plate.

In one embodiment, the parts of the device according to the invention are made of sintered metal. In an alternative embodiment, the parts of the device according to the invention are cut from a solid.

The present application describes various technical features and advantages with reference to the figures and/or to various embodiments. A person skilled in the art will understand that the technical characteristics of a given embodiment can in fact be combined with features of another embodiment unless the contrary is specifically mentioned or it is evident that the features are incompatible. Moreover, the technical features described in a given embodiment can be isolated from other features of that embodiment unless the contrary is explicitly mentioned.

It should be obvious to persons skilled in the art that the present invention allows embodiments in many other specific forms without departing from the field defined by the scope of the appended claims, and the invention must not be limited to the details given above.

1. An angular velocity reduction device comprising a first circular element (1) passing through the center of a fixed plate (8) and freely rotating with respect to said plate at an angular velocity W1, wherein the first element (1) is meshing with a second element (2) including at least one planet gear (20) integral with the fixed plate through an end piece (21) as a single piece with said planet gear and serving as an axis of rotation, each planet gear (20) being freely rotatable with respect to the fixed plate (8) and driven by the first element (1), the planet gears (20) being in contact with the inside of a first ring gear (4) driven by the second element (2) at the angular velocity W2, said ring gear (4) and the first element (1) being concentric, the first ring gear being made integral with a second ring gear (5) so that the first ring gear drives said second ring gear (5) at the same angular velocity W2, one of the two ring gears (4, 5) comprising a skirt (50) without teeth wherein is fitted the other ring gear (4), a third element (3) being meshing with the first element (1) and the internal portion (51) of the second ring gear (5), the center of the third element (3) being driven by the first element and the second ring gear at the angular velocity WO3 along a circular trajectory with a predetermined radius (R3) intermediate between the radius (R1) of the first element and the internal radius (R2) of the second ring gear, the third element comprising at least one planet gear (30) mounted freely rotatable in an output plate (6) through an end piece (31) as a single piece with the planet gear (30) and serving as an axis of rotation, each planet gear being freely rotatable about its axis, the third element (3) driving the output plate (6) at the angular velocity W3, the output plate further comprising at least one end piece (60) serving as an output axis, this axis and the first element (1) being concentric, the parts (1, 2, 3, 4, 5, 6, 8, 9) of the device being inserted into a guide tube (7) positioned in the flange (B) or the frame of a motor, the outside diameter of the second ring gear (5) and the diameter of the output plate (6) of the device being equal and matched with the diameter of the bore of the guide tube (7) so that there is no mechanical clearance between on the one hand the internal wall of the guide tube (7) and on the other hand the output plate (6), the third element (3) and the second ring gear (5), the guide tube (7) further comprising at its other end an annular rim designed to accommodate an attachment plate (9) positioned facing the output plate (6) and attached to the guide tube (7) via at least one screw or one pin, the attachment plate (9) comprising an opening through which protrudes the end piece (60) of the output plate (6) serving as an output axis, said end piece (60) being freely rotatable with respect to the attachment plate (9).

2. The angular velocity reduction device according to claim 1, wherein each end piece (21, 31) of the planet gears (20, 30) of the second (2) and third (3) elements comprises at its end a blocking system (C) preventing the planet gear (20, 30) from disengaging from the corresponding plate (6, 8) wherein said planet gear (20, 30) is rotatably mounted.

3. The angular velocity reduction device according to claim 1, wherein the parts (1, 2, 3, 4, 5, 6, 8, 9) of the device are made of sintered metal or cut from the solid.

4. The angular velocity reduction device according to claim 1, wherein on the one hand the first element (1) consists of the axis of the motor in which are formed two pinions (11, 12), the first pinion (11) driving the second element (2) and the second pinion (12) driving the third element (3), and on the other hand the fixed plate (8) is integral with the frame (B) of the motor.

5. The angular velocity reduction device according to claim 1, wherein on the one hand the first element (1) comprises an axis (10) driven by the motor, said axis including a first pinion (11) rigidly mounted on the axis and driving the second element (2), the axis (10) further comprising a second pinion (12) rigidly mounted on the axis and driving the third element (3), the inside diameter (Di1) of the first pinion (11) being greater than the outside diameter (De2) of the second pinion (12), and on the other hand that the fixed plate (8) is integral with the frame (B) of the motor.

6. The angular velocity reduction device according to claim 1, wherein on the one hand the first element (1) comprises an axis (10) driven by the motor, said axis comprising a first pinion (11) rigidly mounted on the axis and driving the second element (2), a second pinion (12) driving the third element (3) being directly formed in the axis (10) and on the other hand the fixed plate (8) is integral with the frame (B) of the motor.

7. The angular velocity reduction device according to claim 1, wherein the teeth of the pinions (11, 12) of the first element (1) are different.

8. The angular velocity reduction device according to claim 1, wherein the first element (1) consists of the axis of the motor in which is formed a single pinion (11) driving both the second element (2) and the third element (3).

9. The angular velocity reduction device according to claim 1, wherein the pinions (11, 12), planet gears (20, 30) and ring gears (4, 5) have the same module.

10. The angular velocity reduction device according to claim 1, wherein the teeth of the two ring gears (4, 5) are different.

11. The angular velocity reduction device according to claim 1, wherein one of the two ring gears (4, 5) is attached to the inside of the ring gear (4, 5) comprising a skirt, using at least one pin (45) or at least one screw inserted parallel or perpendicular to the axis (10) of the first element (1).

12. The angular velocity reduction device according to claim 1, wherein the end pieces (21, 31) serving as axes for the planet gears (20, 30) of the second (2) and third (3) element comprise a groove (G) in a perpendicular plane to the axis of symmetry of the planet gear, an O-ring (J) being designed to be inserted into this groove so that the connection between the axis (21, 31) of each planet gear (20, 30) and the corresponding plate (8, 9) is sealed while still ensuring free rotation in the plate of the planet gear about its axis.

13. The angular velocity reduction device according to claim 1, wherein the guide tube (7) comprises at one end at least one shoulder (70), for holding the fixed plate (8) and allowing the attachment of the guide tube (7) onto the frame (B) or the flange of the motor using at least one screw or one pin (71).

14. The angular velocity reduction device according to claim 1, wherein the parts (1, 2, 3, 4, 5, 6, 8, 9) of the device as well as the frame (B) of the motor are inserted into the guide tube (7).

15. The angular velocity reduction device according to claim 1, wherein the output plate (6) comprises a second end piece (61) serving as an output axis, the first and second end pieces being aligned and positioned on either side of the output plate (6), the second end piece (61) being designed to be inserted into the axis (10) of the first element (1), said axis being hollow and with an inside diameter greater than the diameter of the second end piece (61) so that the latter is freely rotating at the angular velocity WO3.
